(19) United States
(12) Patent Application Publication
(10) Pub. No.: US 2026/0099130 A1
(43) Pub. Date: Apr. 9, 2026

(54) SYSTEMS AND METHODS FOR DEVICE OPTIMIZATION

(71) Applicant: Sensia Netherlands B.V., Rotterdam (NL)

(72) Inventors: Derek Meier, Katy, TX (US); Srikanth G. Mashetty, Houston, TX (US); Jonathan Wun Shiung Chong, Calgary (CA); Yasser El-Khazindar, London (GB); Thomas Madden, Duncan, OK (US); Norman Andrew Weatherhead, Kitchener (CA)

(21) Appl. No.: 19/350,746

(22) Filed: Oct. 6, 2025

Related U.S. Application Data
(60) Provisional application No. 63/704,361, filed on Oct. 7, 2024.

(51) Int. Cl. G05B 19/042; G06F 9/451

(52) U.S. Cl. CPC G05B 19/0426; G06F 9/451; G05B 2219/23258

(57) ABSTRACT

A system includes industrial equipment providing operations of an oil-and-gas facility, a user interface device, and a control system. The control system is programmed to provide, the user interface device, a graphical user interface configured to prompt a user to select a performance indicator associated with the operations and adjust a plurality of constraints on a plurality of variables relating to the operations. The control system is further programmed to perform an optimization process configured to determine settings for the operations that optimize the performance indicator subject to the plurality of constraints and operate the industrial equipment in accordance with the settings.

### CROSS-REFERENCE TO RELATED APPLICATION

This application claims the benefit of and priority to U.S. Provisional Application No. 63/704,361 filed Oct. 7, 2024, the entire disclosure of which is incorporated by reference herein.

### BACKGROUND

The present disclosure relates generally to industrial devices, for example controllers and other devices in industrial systems. More specifically, the present disclosure relates to systems and methods to optimizing operation of devices in industrial systems, such as an oil-and-gas facility.

### SUMMARY

One implementation of the present disclosure is a system. The system can include industrial equipment providing operations of an oil-and-gas facility, a user interface device, and a control system. The control system can be programmed to provide, the user interface device, a graphical user interface configured to prompt a user to select a performance indicator associated with the operations and adjust a plurality of constraints on a plurality of variables relating to the operations. The control system can be further programmed to perform an optimization process configured to determine settings for the operations that optimize the performance indicator subject to the plurality of constraints and operate the industrial equipment in accordance with the settings.

One implementation of the present disclosure is a method. The method can include providing, the user interface device, a graphical user interface configured to prompt a user to select a performance indicator associated with the operations and adjust a plurality of constraints on a plurality of variables relating to the operations. The method can further include performing an optimization process configured to determine settings for the operations that optimize the performance indicator subject to the plurality of constraints and operating the industrial equipment in accordance with the settings.

### BRIEF DESCRIPTION OF THE DRAWINGS

FIG. 1 is a perspective view of a hydrocarbon site equipped with well devices, according to some embodiments.

FIG. 2 is a block diagram of a control system for the hydrocarbon site of FIG. 1, according to some embodiments.

FIG. 3 is a block diagram of a portion of the control system of FIG. 2, showing a converged controller communicating with field equipment, input devices, and output devices, according to some embodiments.

FIG. 4 is a block diagram of a system including the converged controller and a computing platform, according to some embodiments.

FIG. 5 is a block diagram of a computing platform, which can be implemented by the system of FIG. 4, according to some embodiments.

FIG. 6 is a block diagram of another computing platform, which can be implemented by the system of FIG. 4, according to some embodiments.

FIG. 7 is a block diagram of a control system, which can be implemented by the system of FIG. 4, according to some embodiments.

FIG. 8 is a flow diagram of a method for operating in accordance with settings, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

Referring generally to the FIGURES, a device optimizer can be installed on one or more edge devices, converged controllers, field controllers, or any other device used to monitor and operate oil-and-gas facilities (e.g., oil extraction site). The present disclosure relates generalizing to assisting users in identifying constraints and areas of optimization for the oil-and-gas facilities. Systems and methods of the present disclosure may provide users with a visual interface to efficiently communicate system statuses and constraints. Each of the constraints presented to the user may be assigned a response. For example, at a well site, responsive to the user selecting to decrease a pump intake pressure, the response may be to increase a variable speed drive (VSD) frequency. Approaches herein can simplify and increase an efficiency of users optimizing performance of the oil-and-gas facilities. Furthermore, by using a simplified constraint and rules engine to generate the response, the approaches herein can avoid usages of physics or data models to determine optimization routes for the oil-and-gas facilities. In some embodiments, the device optimizer may receive changes in constraints of the oil-and-gas facilities in real-time, and adjust the responses generated simultaneously.

While the systems and methods disclosed can be used to monitor, control, and improve industrial equipment, the systems and methods can also be used for advising devices for a variety of implementations such as manufacturing equipment. The systems and methods herein can continually update and improve with continued user usage and input.

### Hydrocarbon Site Overview

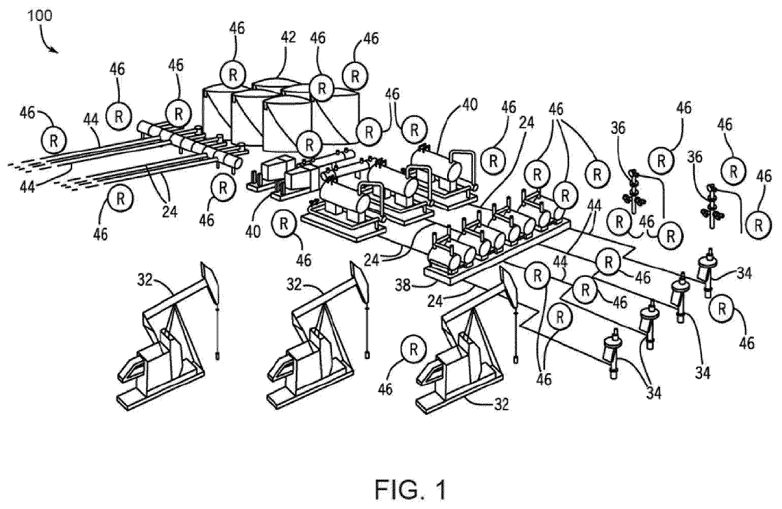

Referring now to FIG. 1, a hydrocarbon site 100 (e.g., an oil-and-gas facility) can be an area in which hydrocarbons, such as crude oil and natural gas, can be extracted from the ground, processed, and/or stored. As such, the hydrocarbon site 100 can include a number of wells and a number of well devices that can control the flow of hydrocarbons being extracted from the wells. In one embodiment, the well devices at the hydrocarbon site 100 can include any device equipped to monitor and/or control production of hydrocarbons at a well site. As such, the well devices can include pumpjacks 32, submersible pumps 34, well trees 36, and other devices for assisting the monitoring and flow of liquids or gasses, such as petroleum, natural gasses and other substances. After the hydrocarbons are extracted from the surface via the well devices, the extracted hydrocarbons can be distributed to other devices such as wellhead distribution manifolds 38, separators 40, storage tanks 42, and other devices for assisting the measuring, monitoring, separating, storage, and flow of liquids or gasses, such as petroleum, natural gasses and other substances. At the hydrocarbon site 100, the pumpjacks 32, submersible pumps 34, well trees 36, wellhead distribution manifolds 38, separators 40, and storage tanks 42 can be connected together via a network of pipelines 44. As such, hydrocarbons extracted from a reservoir can be transported to various locations at the hydrocarbon site 100 via the network of pipelines 44.

The pumpjack 32 can mechanically lift hydrocarbons (e.g., oil) out of a well when a bottom hole pressure of the well is not sufficient to extract the hydrocarbons to the surface. The submersible pump 34 can be an assembly that can be submerged in a hydrocarbon liquid that can be pumped. As such, the submersible pump 34 can include a hermetically sealed motor, such that liquids cannot penetrate the seal into the motor. Further, the hermetically sealed motor can push hydrocarbons from underground areas or the reservoir to the surface.

The well trees 36 or Christmas trees can be an assembly of valves, spools, and fittings used for natural flowing wells. As such, the well trees 36 can be used for an oil well, gas well, water injection well, water disposal well, gas injection well, condensate well, and the like. The wellhead distribution manifolds 38 can collect the hydrocarbons that can have been extracted by the pumpjacks 32, the submersible pumps 34, and the well trees 36, such that the collected hydrocarbons can be routed to various hydrocarbon processing or storage areas in the hydrocarbon site 100.

The separator 40 can include a pressure vessel that can separate well fluids produced from oil and gas wells into separate gas and liquid components. For example, the separator 40 can separate hydrocarbons extracted by the pumpjacks 32, the submersible pumps 34, or the well trees 36 into oil components, gas components, and water components. After the hydrocarbons have been separated, each separated component can be stored in a particular storage tank 42. The hydrocarbons stored in the storage tanks 42 can be transported via the pipelines 44 to transport vehicles, refineries, and the like.

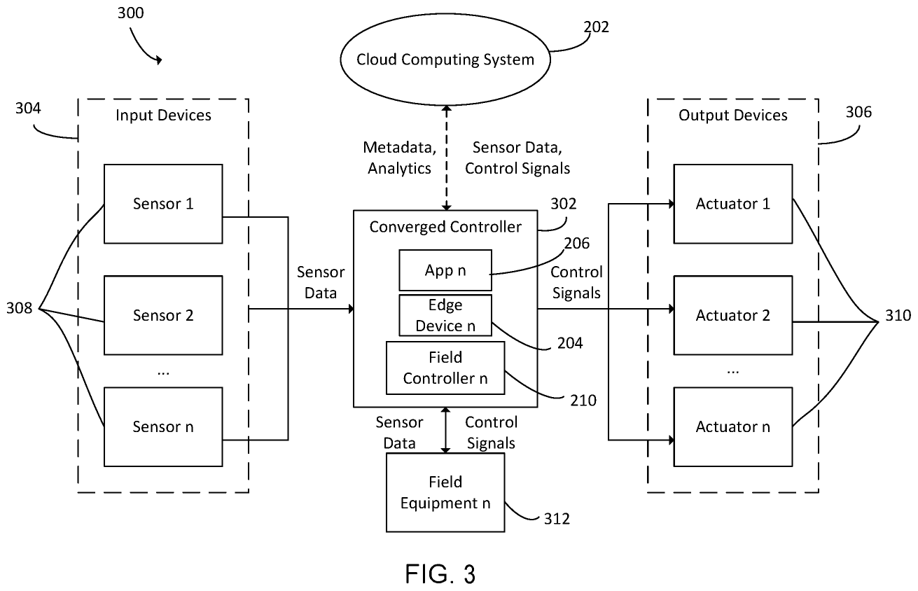

The well devices can also include monitoring systems that can be placed at various locations in the hydrocarbon site 100 to monitor or provide information related to certain aspects of the hydrocarbon site 100. As such, the monitoring system can be a controller, a remote terminal unit (RTU), or any computing device that can include communication abilities, processing abilities, and the like. For discussion purposes, the monitoring system will be embodied as the RTU 46 throughout the present disclosure. However, it should be understood that the RTU 46 can be any component capable of monitoring and/or controlling various components at the hydrocarbon site 100. The RTU 46 can include sensors or can be coupled to various sensors that can monitor various properties associated with a component at the hydrocarbon site 100. In some embodiments, one or more of the RTUs 46 of FIG. 1 are configured as one or more converged controllers 302 as shown in FIG. 3 and described below.

The RTU 46 can then analyze the various properties associated with the component and can control various operational parameters of the component. For example, the RTU 46 can measure a pressure or a differential pressure of a well or a component (e.g., storage tank 42) in the hydrocarbon site 100. The RTU 46 can also measure a temperature of contents stored inside a component in the hydrocarbon site 100, an amount of hydrocarbons being processed or extracted by components in the hydrocarbon site 100, and the like. The RTU 46 can also measure a level or amount of hydrocarbons stored in a component, such as the storage tank 42. In certain embodiments, the RTU 46 can be iSens-GP Pressure Transmitter, iSens-DP Differential Pressure Transmitter, iSens-MV Multivariable Transmitter, iSens-T2 Temperature Transmitter, iSens-L Level Transmitter, or Isens-1O Flexible 1/0 Transmitter manufactured by vMonitor® of Houston, Texas.

In one embodiment, the RTU 46 can include a sensor that can measure pressure, temperature, fill level, flow rates, and the like. The RTU 46 can also include a transmitter, such as a radio wave transmitter, which can transmit data acquired by the sensor via an antenna or the like. The sensor in the RTU 46 can be wireless sensors that can be capable of receive and sending data signals between RTUs 26. To power the sensors and the transmitters, the RTU 46 can include a battery or can be coupled to a continuous power supply. Since the RTU 46 can be installed in harsh outdoor and/or explosion-hazardous environments, the RTU 46 can be enclosed in an explosion-proof container that can meet certain standards established by the National Electrical Manufacturer Association (NEMA) and the like, such as a NEMA 4X container, a NEMA 7X container, and the like.

The RTU 46 can transmit data acquired by the sensor or data processed by a processor to other monitoring systems, a router device, a supervisory control and data acquisition (SCADA) device, or the like. As such, the RTU 46 can enable users to monitor various properties of various components in the hydrocarbon site 100 without being physically located near the corresponding components. The RTU 46 can be configured to communicate with the devices at the hydrocarbon site 100 as well as mobile computing devices via various networking protocols.

In operation, the RTU 46 can receive real-time or near real-time data associated with a well device. The data can include, for example, tubing head pressure, tubing head temperature, case head pressure, flowline pressure, wellhead pressure, wellhead temperature, and the like. In any case, the RTU 46 can analyze the real-time data with respect to static data that can be stored in a memory of the RTU 46. The static data can include a well depth, a tubing length, a tubing size, a choke size, a reservoir pressure, a bottom hole temperature, well test data, fluid properties of the hydrocarbons being extracted, and the like. The RTU 46 can also analyze the real-time data with respect to other data acquired by various types of instruments (e.g., water cut meter, multiphase meter) to determine an inflow performance relationship (IPR) curve, a desired operating point for the wellhead 30, key performance indicators (KPis) associated with the wellhead 30, wellhead performance summary reports, and the like. Although the RTU 46 can be capable of performing the above-referenced analyses, the RTU 46 cannot be capable of performing the analyses in a timely manner. Moreover, by just relying on the processor capabilities of the RTU 46, the RTU 46 is limited in the amount and types of analyses that it can perform. Moreover, since the RTU 46 can be limited in size, the data storage abilities can also be limited.

In certain embodiments, the RTU 46 can establish a communication link with the cloud-based computing system 12 described above. As such, the cloud-based computing system 12 can use its larger processing capabilities to analyze data acquired by multiple RTUs 26. Moreover, the cloud-based computing system 12 can access historical data associated with the respective RTU 46, data associated with well devices associated with the respective RTU 46, data associated with the hydrocarbon site 100 associated with the respective RTU 46 and the like to further analyze the data acquired by the RTU 46. The cloud-based computing system 12 is in communication with the RTU via one or more servers or networks (e.g., the Internet).

In some embodiments, the best operating point of a submersible downhole pump can be determined by performing an optimization process. For example, model-based optimization or artificial intelligence can be used in order to determine an operating point (i.e., operating pressure, flow, and/or speed of the pump). In some embodiments, the optimization process can include determining the set of wells and the corresponding pump operating points in order to hit a certain production constraint while operating efficiently. In some embodiments, the best operating point can be transmitted to a motor optimization system.

### Site Control System

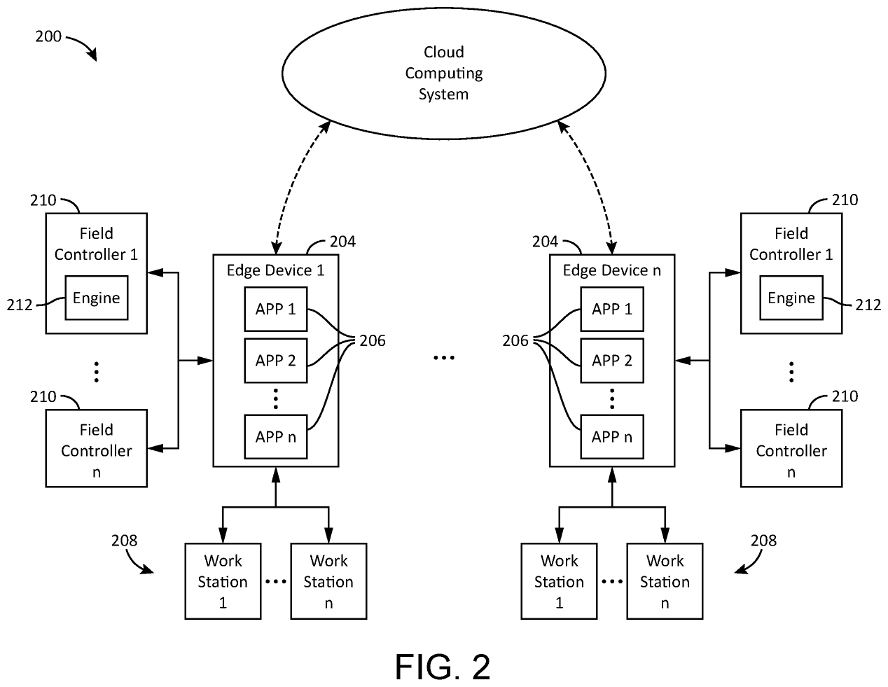

Referring particularly to FIG. 2, control system 200 for hydrocarbon site 100 is shown, according to some embodiments. In some embodiments, control system 200 includes or is configured to communicate with cloud computing system 202 and is configured to control various operations of a well site (e.g., hydrocarbon site 100, oil-and-gas facility) based on analyzing metadata from various devices within control system 200. Cloud computing system 202 may include any processing circuitry, processors, memory, etc., or combination thereof that are positioned remotely from hydrocarbon site 100. In various embodiments, some or all of the processing circuity, processors, memory, etc., or combination thereof within cloud computing system 202 may be performed by various devices disclosed within control system 200. Control system 200 is further shown to include edge devices 204, and workstations 208, and field controllers 210. Edge device (n) 204, workstation (n) 208, and field controller (n) 210 as seen in FIG. 2 indicate any number of the edge device 204, workstation 208, and field controller 210 can be implemented in the control system 200.

While cloud computing system 202 is generally disclosed herein as performing some or all of the functionality of the methods disclosed herein, cloud-based architecture (e.g., cloud computing system 202 connected to edge device(s) 204 and field controller 210, etc.) is purely an exemplary embodiment and is not intended to be limiting. In some embodiments, the methods disclosed herein may be implemented by systems that do not include or utilize a cloud-based computing system (e.g., cloud computing system 202). In some embodiments, the systems and methods disclosed herein are architecture agnostic, such that they may be implemented across a variety of architectures including private or on-premise server infrastructure.

Edge devices 204 may be configured to run, perform, implement, store, etc., one or more applications 206 thereof. Application (n) 206 indicates any number of the application 206 can be run on the edge devices 204. Additionally, some or all processing circuity, processors, memory, etc. included in various devices within control system 200 (e.g., edge device 204, field controller 210, workstation 208, etc.) may be distributed across several other devices within control system 200 or integrated into a single device. Edge device(s) 204 may be configured to receive data from field controller(s) 210 and provide data analytics to cloud computing system 202 based on the received data. This is described in greater detail below with reference to FIG. 3.

In some embodiments, each edge device 204 includes a processing circuit having a processor and memory. The processor can be a general purpose or specific purpose processor, an application specific integrated circuit (ASIC), one or more field programmable gate arrays (FPGAs), a group of processing components, or other suitable processing components. The processor is configured to execute computer code or instructions stored in the memory or received from other computer readable media (e.g., CDROM, removable USB drive, network storage, a remote server, etc.), according to some embodiments.

In some embodiments, the memory can include one or more devices (e.g., memory units, memory devices, storage devices, etc.) for storing data and/or computer code for completing and/or facilitating the various processes described in the present disclosure. The memory can include random access memory (RAM), read-only memory (ROM), hard drive storage, temporary storage, non-volatile memory, flash memory, optical memory, or any other suitable memory for storing software objects and/or computer instructions. The memory can include database components, object code components, script components, or any other type of information structure for supporting the various activities and information structures described in the present disclosure. The memory can be communicably connected to the processor via the processing circuitry and can include computer code for executing (e.g., by the processor) one or more processes described herein.

In some embodiments, various edge device(s) 204 may include some or all functionality of remote terminal units (RTUs) (e.g., RTU 46). In various embodiments, edge device(s) 204 is not limited to the functionality of RTU's and can include other controller features. Similarly, RTU's, as described herein, may refer to any industrial edge controller which is programmable and/or capable of one or more applications, either individually or as a module within a broader system (e.g., system 200).

Field controllers 210 may be configured to control various operations at a well site and are communicably coupled with edge devices 204. In some embodiments, field controllers 210 are configured to operate (e.g., provide control signals to, provide setpoints to, adjust setpoints or operational parameters thereof) field equipment (e.g., electric submersible pumps (ESPs), cranes, pumps, etc.) of hydrocarbon site 100. Field controllers 210 may be grouped into different sets based on which edge device 204 field controller 210 communicate with. In some embodiments, edge device(s) 204 are configured to exchange any sensor data, measurement data, meter data (e.g., flow meter data), storage data, maintenance data, control signals, setpoint adjustments, operational adjustments, diagnostic data, analytics data, meta data, etc., with field controllers 210. It should be understood that each edge device 204 can be associated with, corresponding to, etc., multiple field controllers 210.

In some embodiments, one or more of field controllers 210 can include a computing engine 212. Computing engine 212 can be configured to perform various control, diagnostic, analytic, reporting, meta data-related, etc., functions. Computing engine 212 can be embedded in one or more of field controller 210 or may be embedded at one or more of edge devices 204. In some embodiments, any of the functionality of computing engine 212 is distributed across multiple edge devices 204 and/or multiple field controllers 210. In some embodiments, any of the functionality of computing engine 212 is performed by cloud computing system 202.

Still referring to FIG. 2, workstations 208 may be configured to receive user instructions for controlling hydrocarbon site 100 and provide control signals to various devices via control system 200. Workstations 208 can include any desktop computer, laptop computer, personal computer device, user interface, personal computer device, etc., or any general computing device thereof. In some embodiments, multiple workstations 208 (e.g., an n number of workstations 208) are associated with each edge device 204, while in other embodiments, one or more of edge devices 204 are associated with a single work station 208.

In some embodiments, field controller(s) 210 may be configured to act as edge devices such that field controller(s) 210 perform additional processing (e.g., data analysis, mapping, etc.) prior to providing information to cloud computing system 202. In some embodiments, this decreases latency in information processing to cloud computing system 202. In other embodiments, edge device(s) 204 operate as traditional edge devices and perform significant storage and processing within control system 200 (e.g., on-site, at/near hydrocarbon site 100, etc.) to mitigate latency due to processing information in cloud computing system 202.

### Converged Controller System

Referring now to FIG. 3, control system 300 for performing control of output devices 306 based on input devices 304 is shown, according to exemplary embodiments. Control system 300 is shown to include a converged controller 302 including edge device 204, application 206, cloud computing system 202, field controller 210, field equipment 312 (e.g., oil-and-gas equipment), input devices 304, and output devices 306. Field equipment (n) 312 indicates that any number of the field equipment 312 can be included in the control system 300.

The converged controller 302 can be a device configured to function as and include the edge device 204 and the field controller 210. In some embodiments, the converged controller 302 includes all the functionality of the edge device 204 and the field controller 210. For example, the converged controller 302 includes a controller portion and a compute portion. For example, the converged controller 302 can both control equipment (e.g., via the controller portion) and optimize performance of the equipment by adjusting parameters of the equipment (e.g., via the compute portion). The converged controller 302 can be, for example, a HCC2 controller manufactured by Sensia LLC in some embodiments. The HCC2 controller can include analog acquisition hardware and software. In some embodiments, the converged controller 302 includes wired or wireless communication interfaces (e.g., jacks, antennas, transmitters, receivers, transceivers, transmitters, wire terminals, etc.) for conducting data communications with various edge devices, RTUs, converged controllers, and/or cloud computing system 202. For example, the converged controller 302 can include a Wi-Fi transceiver, cellular, or mobile phone communication transceivers for communication via wireless communication network.

Input devices 304 may be configured to provide various sensor data and/or field measurements from hydrocarbon site 100 to the converged controller 302 for processing. For example, sensor 308 of input devices 304 is measuring the pump speed of pump 34. Sensor 308 provides the pump speed of pump 34 to converged controller 302 at regular intervals (e.g., continuously, ever minute, every 5 minutes, etc.). Input devices 304 may be connected wired or wirelessly to converged controller 302 or any other device within system 300. In some embodiments, input devices 304 are coupled to various site equipment (e.g., pumps, pump jacks, cranes, etc.) and provide operational data of their respective site equipment to converged controller 302.

In some embodiments, sensor(s) 308 refer to physical sensors (e.g., temperature sensors, flow sensors, etc.) and/or virtual sensors (e.g., inferential sensors, soft sensors, etc.). In some embodiments, virtual sensors provide identical or similar information as would a physical sensor, only via software applications. In some embodiments, virtual sensors learn to interpret the relationships between the different variables and observe readings from various instruments. For example, rather than implementing several physical sensors at a site (e.g., hydrocarbon site 100), one or more virtual sensors may be placed on a simulation model to achieve identical or similar results.

Output devices 306 may be configured to receive control signals from converged controller 302 and adjust operation based on the received control signals. For example, converged controller 302 determines that pump 34 is operating at a lower pump speed than is considered optimal. The converged controller 302 subsequently sends a control signal to actuator 310 to increase pump speed for pump 34. In some embodiments, output devices 306 are configured to act as any device (e.g., actuator, etc.) capable of adjusting operation of site equipment within hydrocarbon site 100. In some embodiments, various other field equipment (e.g., field equipment 312) include some or all of the functionality of input devices 304 and output devices 306 and provide sensor data and receive control signals from converged controller 302. As seen in FIG. 3, sensor (n) 308 and actuator (n) 310 indicates that any number of the sensor 308 and the actuator 310 can be included and used by the control system 300.

In some embodiments, control system 300 is configured to analyze various sets of data (e.g., metadata) to determine control schema that is optimal for hydrocarbon site 100. A significant amount of processing for this may be performed by converged controllers (e.g., converged controller 302), instead of processing all metadata analytics in the cloud, as processing the data in on-site or proximate edge devices can decrease latency compared to sending the data to cloud computing system 202 for processing. For example, sensors 308 provide metadata to converged controller 302. Converged controller 302 processes the data to determine the type of data and/or domain from which the data is received and analyzes the data. An application within converged controller 302 e.g., application 206) may analyze the metadata to make decisions about the control schema that would have been otherwise unnoticed by processing within control system 300. For example, application 206 may infer that the data received has been received by a flow meter sensor (e.g., sensor (1) 308), based on the patterns seen in the data and a prior data that converged controller 302 has analyzed. Application 206 may make inferences, predictions, and calculations based on current and/or past data.

In some embodiments, application 206 provides some or all of the data to cloud computing system 202 for further processing. Application 206 may be configured to make inferences about received data that improves the standardization of data analytics. For example, sensor (1) 308 and sensor (2) 308 may be flow sensors, but from different vendors. As such, sensor (1) 308 may provide data to field controller 210 in a different format than sensor (2) 308. However, application 206 of the converged controller 302 may still be able to standardize the data and determine that both sets of data are from flow sensors, despite the received data being in different formats (e.g., one data set is provided under resource description framework (RDF) specifications, one data set is provided as data objects, etc.). In various embodiments, allowing converged controller 302 to perform some or all of the metadata analytics allows for improved data analytics and control schema without significantly increasing processing latency.

In various embodiments, the control system 300 does not include the converged controller 302, and, instead includes the edge device 204 and the field controller 210. The application 206 can then be installed on the edge device 204, and the edge device 204 and/or the field controller 210 can receive input and control the input devices 304 and the output devices 306 as well as the field equipment 312.

### Device Advisors

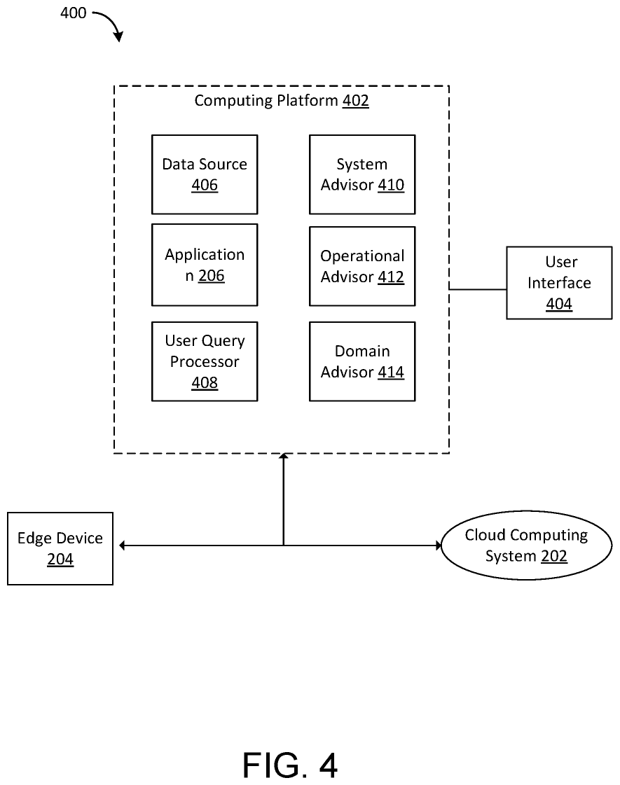

Referring now to FIG. 4, a system 400 is shown, according to some embodiments. System 400 is shown to include a computing platform 402, the cloud computing system 202, and the edge device 204. In some embodiments, the computing platform 402 is configured to assist in operations and management of the edge device 204. In some embodiments, the computing platform 402 is configured provide assistance to users of the edge device 204, a converged controller (e.g., the converged controller 302), and/or a field controller (e.g., field controller 210).

The system 400 can include one or more user interfaces 404. The user interface 404 can be an interface, HDMI interface, a screen, mobile device, etc., that provides supervisory control and user interaction capabilities to a user associated with the edge device 204. For example, the user interface 404 can be a touch screen mounted to the edge device 204 and allow for user input and control. In other embodiments, the user interface 404 is coupled to the cloud computing system 202. In this case, the user interface 404 can allow for remote monitoring and control of the field equipment 312. The user interface 404 can receive text, video, and/or image input.

Still referring to FIG. 4, the system 400 can include one or more computing platforms 402. The computing platform 402 can be configured to monitor, control, and improve functionality of the edge device 204. The computing platform 402 can utilize an enterprise data management (EDM) with industrial internet of things (IIoT) framework to operate the edge device 204, monitor the field equipment 312, etc. The computing platform 402 can include one or more processors and one or more non-transitory computer-readable medium storing program instructions to be executed by the one or more processors to provide the operations attributed to the computing platform 402 or its components herein. For example, the computing platform 402 can receive user input from the user interface 404 and execute an operation as indicated by the user as described further herein. Various functions described with reference to the components of the system 400 described further herein can be performed in various orders and/or combined or moved to other components of the system 400.

The computing platform 402 can include one or more data sources 406. The data sources 406 can include any of various databases, data sets, or data repositories, for example. The data source 406 can be maintained by one or more entities, which may be entities that maintain the system 400 or may be separate from entities that maintain the system 400. For example, the data source 406 can be maintained by the cloud computing system 202. The data source 406 can receive data from the user, third parties, and/or the cloud computing system 202. The data source 406 can include process automation, domain knowledge procedures, and application (e.g., application 206) documentation repository and source code. In addition, the data source 406 can include an application layer service domain which can include encapsulating security payload (ELS), port control protocol (PCP), global location (GL), and resource reservation protocol (RRP).

The computing platform 402 can include one or more user query processors 408. The user query processor 408 can be a machine learning model (e.g., generative AI). The user query processor 408 can be a large language model (LLM). The user query processor 408 can be a foundational multimodal LLM. The user query processor 408 can be trained by answers generated via various generative AI models as well as system manuals (e.g., manuals of the edge device 204). The user query processor 408 can receive a user query, and respond to the user query. The user query can include text, image, and/or video (e.g., visual query). The user query can be a free-text query. The user query processor 408 can tokenize the user query, determine a context of the user query, and generate a response. The response to the user query can include an actionable response. The actionable response can be an action (e.g., task) to be performed by at least one of the user and/or the edge device 204 and/or the oil-and-gas facility. For example, the user query can be a question about improving performance of the field equipment 312. In response, the user query processor 408 can generate the actionable response which could include adjusting parameters of the field equipment 312. The parameters can then be adjusted by the edge device 204 and/or the field controller 210. In some embodiments, the actionable response can include parameter modifications for the edge device 204. The parameter modifications can be based on hyperparameters of the one or more advisor models. The hyperparameters of the one or more advisor models can reflect updated (e.g., current) edge device 204 performance constraints (e.g., processing power, data acquisition, etc.). The user query processor 408 can thus take into account the performance constraints of the edge device 204 to generate the actionable response (e.g., parameter modifications).

The computing platform 402 can include one or more advisor models. The advisor models are shown as being a system advisor 410, an operational advisor 412, and a domain advisor 414. The advisor models can be machine learning models (e.g., LLMs). The advisor models can be fine-tuned (e.g., adapted) by updating hyperparameters of the advisor models through continued user input (e.g., user interaction). The advisor models can also be fine-tuned by being fed prompt-based and/or interactive objective design and/or any other knowledge (e.g., data) in real-time for automation and control of the edge device 204 and/or the field equipment 312. For example, the hyperparameters of the advisor models can be adjusted to conform to performance requirements and constraint requirements of the hydrocarbon site 100. The hyperparameters can further be adjusted based on improved performance and/or multiple constraint handling under confliction of the field equipment 312. In this case, the hyperparameters are adjusted for dynamic problems where constraints and/or objectives of the field equipment 312 are to be turned in real-time with user interaction and/or input.

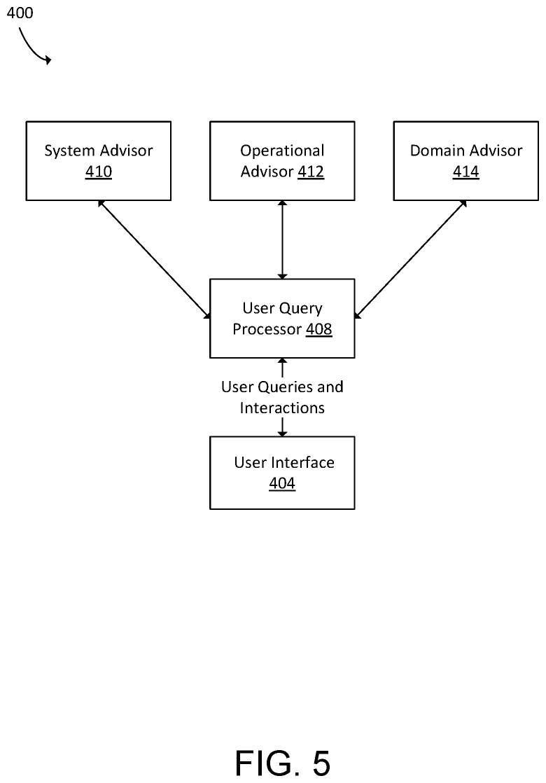

As seen in FIG. 5, the user query processor 408 can sort the user query to at least one of the advisor models to generate a response to the user query. The user query processor 408 can sort the user query based on a content and context of the user query. The advisor models can include at least one system advisor 410, operational advisor 412, and domain advisor 414. Each of the advisor models can perform different operations (e.g., different advisor operations), and the user query processor 408 can sort the query based on the operation that the advisor model performs. For example, the system advisor 410 can include a machine learning model configured to perform advisor operations. The advisor operations can include configuring the edge device 204 (e.g., installing the edge device 204) and assisting in developing applications for the edge device 204 (e.g., where an application should be installed). For example, given a user query regarding application development, the user query processor 408 directs the user query to be processed by the system advisor 410. The operational advisor 412 can include a machine learning model configured to perform advisor operations. The advisor operations can further include proposing improvements to and monitoring the edge device 204 (e.g., adjusting parameters and monitoring edge device 204 performance). The domain advisor 414 can include a machine learning model configured to perform advisor operations. The advisor operations can include providing training for the edge device 204 to users (e.g., via the user interface 404). The domain advisor 414 can be continuously updated and fine-tuned based on feedback received during training. For example, the domain advisor 414 can be updated based on user input received while providing training to the user.

The system advisor 410 can develop workflows that enable audit capabilities (e.g., can identify errors in the system 400) and assist in application (e.g., application 206) load balancing and value recognition (e.g., determining application deployment). For example, the system advisor 410 can identify which device and/or geographical location the application 206 should be installed at, and identify what level of architecture the application 206 should be executed at (e.g., hardware layer, user interface 404, etc.). Furthermore, the system advisor 410 can take into account processing capabilities of the edge device 204, networking and telecommunication constraints (e.g., bandwidth, quality of service (QoS), latency, etc.), and data center resources availability when determining where the application 206 should execute. The system advisor 410 can also assist users in developing the application 206.

In some embodiments, the system advisor 410 develops (e.g., generates using generative artificial intelligence) workflows including a workflow steps, for example based on data sources 406. In some such embodiments, the data source 406 can include a set of steps and/or a plurality of the sets of steps (e.g., steps taken in equipment workflows such as commissioning workflows, installation workflows, troubleshooting workflows, process improvement workflows, and the like), and the system advisor 410 can extract the set of steps from the data source 406. In this case, each of the steps in the set of steps can be associated to variables within the application 206 (e.g., data collection rate), and the user can select steps from the set of steps to determine which of the variables to display on the user interface 404. For example, the user can select the variables to display as results, inputs, sequences, and/or record results through the user interface 404 via the set of steps. The user interface 404 can also display the workflow of the set of steps selected by the user and/or generated by the system advisor 410 (e.g., steps to be taken by the user, steps being taken by the system advisor 410 or other element of the system 400, details on how the system advisor 410 is extracting the variables and displaying the variables on the user interface 404). In various embodiments, the system advisor 410 can also capture login information, date, time, and other such information to store in the data source 406 and/or to display on the user interface 404. The steps can be accumulated into a document, database, or table, among others and uploaded to at least one of the data source 406, the computing platform 402, and/or the cloud computing system 202.

In some embodiments, the system advisor 410 can generate an application based on a prompt. In this case, the system advisor 410 can include generation artificial intelligence (AI), and the user query can be a prompt. The prompt can provide instructions, objectives, and/or goals for the application. The system advisor 410 can generate an application (e.g., using generative AI to create software code that, when executed, provides the application) based on the prompt, and can also deploy the application to a target edge device. The target edge device can be determined based on the goals and/or a purpose of the application. The system advisor 410 can also consider processing constraints, a geographical location, and a type of oil-and-gas facility the target edge device is located at.

The system advisor 410 can detect additional devices (e.g., edge devices, converged controllers, etc.) added to the system 400, and reconfigure the system 400 accordingly (e.g., adjust power allocation). For example, the user query processor 408 can sort the query containing a question regarding an impact of adding another edge device to the system 300. The user query processor 408 can then sort the query to the system advisor 410, which can then calculate the impact and display a result to the user via the user interface 404. The system advisor 410 can also monitor the additional devices and record data produced by the additional devices. Based on the data and information of the additional devices, the system advisor 410 can develop training for users for the additional devices. For example, the system advisor 410 can generate templates for applications 206 for the additional devices and/or develop tools to operate the additional devices.

The operational advisor 412 can provide the user with interaction to the edge device 204 via the user interface 404. The operational advisor 412 can monitor the edge device 204 and troubleshoot problems arising from the edge device 204 and/or improve workflows of day to day activities (for example, by adjusting operational parameters used by edge devices 204, adjusting operating schedules for a facility, adjusting maintenance schedules, adjusting facility demands or loads, adjusting workflows executed by facility staff, etc.). For example, the operational advisor 412 can detect an irregularity in gas flow rate of the field equipment 312 by monitoring the edge device 204, and can alert the user to the irregularity. This can be in response to the user query requesting information regarding the gas flow rate. The operational advisor 412 can also execute actionable responses produced by the user query processor 408. For example, the operational advisor 412 can update parameters of the edge device 204 based on hyperparameters of the operational advisor 412 and/or control the field equipment 312. The operational advisor 412 can change a setting used by the edge device 204 based on the actionable response, and control the field equipment 312 using the setting. For example, the operational advisor 412 can shut off the field equipment 312. The settings can include sensor reading, data logging, pulse width modulation (PWM), relay and actuator control, adjusting edge computing software, etc.

The operational advisor 412 can be fine-tuned by prompt-based (e.g., user query-based) and/or interactive objective design (e.g., objective constraints) or any other knowledge that can be fed in real-time for automation and control of, for example, the edge device 204. In this case, the operational advisor 412 can capture performance and constraint requirements of the edge device 204 by tuning hyperparameters of the operational advisor 412. In various embodiments, the hyperparameters of the operational advisor 412 can be tuned by a fine-tuned LLM model (e.g., the user query processor 408). For example, the user query processor 408 can receive queries regarding updated performance requirements of the edge device 204, and adjust the hyperparameters of the operational advisor 412 to reflect updates. The hyperparameters of the operational advisor 412 can be directed towards improved performance and/or handling multiple constraints under confliction (e.g., multiple issues to balance), for example by optimizing a penalty function that provides a weight sum of penalties associated with different constraints on different process variables. Optimization of the hyperparameters can be formulated for dynamic problems where objectives (e.g., cost objectives, emissions objectives, resource consumption objectives, resource production objectives) and/or constraints (e.g., equipment operating limits, resource consumption limits, production limits, bounds on physical conditions,) are tuned in real-time in response to user interaction and/or input. For example, the user, via the user interface 404, can provide one or more objectives for the edge device 204, the operational advisor 412 can then adjust hyperparameters in a way to meet the one or more objectives. In various embodiments, the operational advisor 412 can tune hyperparameters of the system advisor 410 and/or the domain advisor 414. Objectives and constraints used in such embodiments can be user-selected, automatically determined from equipment configuration, and/or generated intelligently by one or more AI models (e.g., an AI agent performing sentiment analysis on user interactions to determine user goals, objectives, and/or preferences for a facility).

The operational advisor 412 can also regularly scan (e.g., at predetermined time interval) the edge device 204 and highlight gaps (e.g., areas of performance improvement) and propose automated fixes (e.g., improvements). The operational advisor 412 can rank the improvements based on a calculated outcome, for example based on an amount of improvement to one or more objectives (e.g., operating costs, resource consumption, resource production, pollution reduction, emissions reduction, equipment uptime, etc.) such that higher-ranked improvements provide a greater impacted on progress towards a goal for a facility, or urgency or other consideration. For example, the operational advisor 412 can simulate the effect of the fix on the edge device 204, and rank the fixes based on the effects (e.g., based on a degree of improvement in one or more metrics, objectives, etc. of interest). Then, as a result, the operational advisor 412 can provide the user with the actionable response. For example, the actionable response can include displaying on the user interface 404 “{High} You are missing cable length stator resistance. This will prevent your application from generating reasonable values. You can find these details on the installation report. Typical values range between 10 and 20”. In this case, the operational advisor 412 has ranked the actionable response by urgency and identified the issue.

Based on the identified issues, the operational advisor 412 can guide the user in solving the issue. In this case, the operational advisor 412 can include a vision and LLM models which can access system manuals and receive information in real-time. For example, the user query processor 408 can sort the query containing “Why am I not seeing my RTU data?” to the operational advisor 412. The operational advisor 412 can then request a photo and/or video from the user which can be input and received via the user interface 404. The operational advisor 412 can then analyze the photo and/or video, and identify solutions to the issue. For example, the operational advisor 412 can communication that “based on your photo, it appears your wires may be backwards”. The operational advisor 412 can also help the user troubleshoot by providing common errors (e.g., different ways the wires could be connected). To do this, the operational advisor 412 can include a context aware chat interface (e.g., LLM) to interact with the user and time-series data to provide user guides, surveillance training, operational insights extracting, and visual dashboards to the user for the edge device 204.

In various embodiments, the edge device 204 can detect a problem within the edge device 204 or the field equipment 312, and request the user query processor 408 for a solution. The user query processor 408 can then sort the request to the advisor models and generate a response. For example, the response can include creating prompts to the user to execute the solution or display results of the edge device 204 to the user or message the user via a user device.

The domain advisor 414 can provide data insights to the user based on a user's area of expertise (e.g., production, maintenance, management, operations, etc.). For example, based on a user profile and the user query containing a request for performance data of the edge device 204, the user query processor 408 can sort the query to the domain advisor 414. Based on the area of expertise, the domain advisor 414 can provide the user with training and learning assistance for the edge device 204 and/or the field equipment 312. For example, each of the areas of expertise can be assigned to a different training model (e.g., machine learning model). In various embodiments, to train the users, the domain advisor 414 can include a gamified chat (e.g., LLM). The gamified chat can capture expert user knowledge via users with expert knowledge of the additional devices interacting with the domain advisor 414. For example, the domain advisor 414 can provide the user with 1-3 options to complete a task (e.g., accessing the set of steps via the system advisor 410). The domain advisor 414 can then ask the user to pick an option among the 1-3 options and optionally improve or correct the option the user picks. The domain advisor 414 can be fine-tuned with further interaction between the LLM and the user. The system advisor 410 can assign points (e.g., experience (XP), Kudos, etc.) to incentive the user to interact with the domain advisor 414 using a reinforcement learning framework. For example, as the user uses and teaches the domain advisor 414, the domain advisor 414 can improve anticipating and completing a task (e.g., generating the actionable response for the user query).

The domain advisor 414 can also train users without any experience with the edge device 204, the field equipment 312, or, for example, the hydrocarbon site 100. The domain advisor 414 can provide a supervised learning platform and tailor the supervised learning platform based on the area of expertise. The domain advisor 414 can utilize information provided by the expert user to develop the supervised learning platform for the users without any experience. In some embodiments, the domain advisor 414 can develop a set of processors and/or resources to accelerate deployment of devices (e.g., the edge device 204). For example, the edge device 204 can include a barcode and/or QR code, and the bar code can be connected to the domain advisor 414 which can provide training to the users on the edge device 204. In some embodiments, the barcode or is also connected to the operational advisor 412, and can provide the user with set up instructions to accelerate deployment and installation of the edge device 204. The barcode can also facilitate maintenance of the edge device 204. In some embodiments, the barcode can be connected to an augmented reality (AR) platform to assist users in deployment, installation, and/or maintenance of the edge device 204.

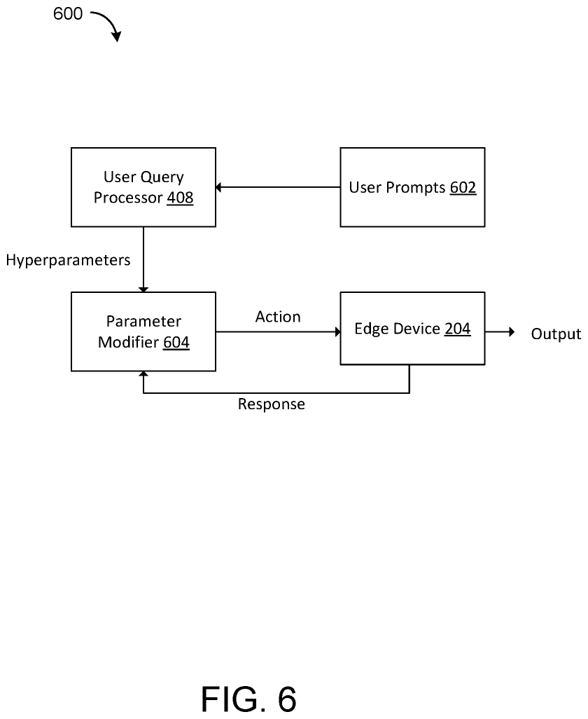

Referring now to FIG. 6, a system 600 is shown, according to some embodiments. System 600 is shown to include user prompts 602, the user query processor 408, a parameter modifier 604, and the edge device 204. In some embodiments, the system 600 can be included or be implemented by at least one of the system 200, 300, or 400. In some embodiments, the system 600 is configured to optimize the edge device 204, a converged controller (e.g., the converged controller 302), and/or a field controller (e.g., field controller 210).

The user query processor 408 can receive user prompts 602 from the user. The user prompts 602 can be user queries, directions, requests, or instructions, among others. The user prompt 602 can be in a form of text, video, and/or photo. The user query processor 408 can then process the user prompt 602, and determine any performance and constraint requirement updates based on the user prompt 602. The user query processor 408 can then generate hyperparameter modifications based on the updated performance and constraint requirements. The parameter modifier 604 can then receive the hyperparameter modifications, and change the hyperparameters of the advisor models. In some embodiments, the parameter modifier 604 is included in the system advisor 410. Following modification of the hyperparameters, the advisor models can generate the actionable response (e.g., action) for the edge device 204 (e.g., shut off the field equipment 312). The edge device 204 can then generate an output to the actionable response (e.g., completing the action), and provide a result of the output to the parameter modifier 604. The result can be used by the parameter modifier 604 to further adjust hyperparameters of the advisor models to achieve a desired output by the user.

### Device Optimizers

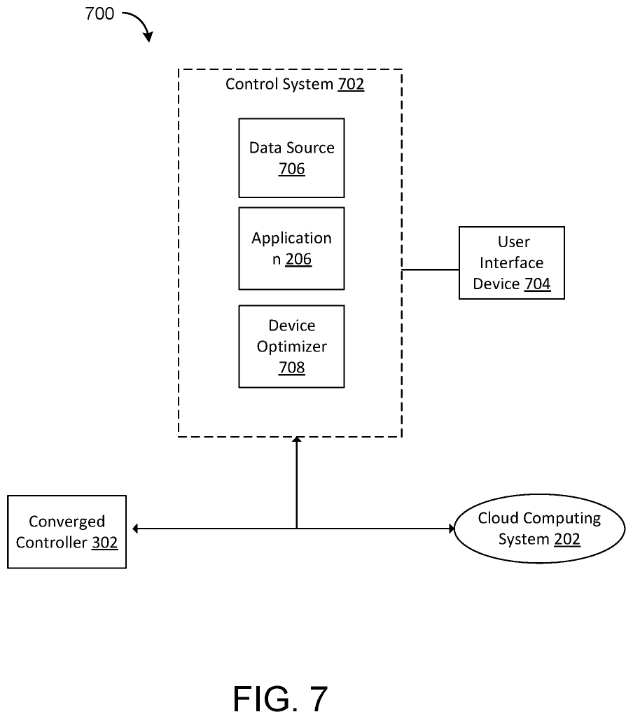

Referring now to FIG. 7, a system 700 is shown, according to some embodiments. System 700 is shown to include a control system 702, the cloud computing system 202, and the converged controller 302. In some embodiments, the control system 702 is configured to assist in operations and management of the converged controller 302. In some embodiments, the control system 702 is configured provide assistance to users of the converged controller 302 and/or a field controller (e.g., field controller 210) and/or an edge device (e.g., the edge device 204). In some embodiments, the system 700 is a part of and/or implemented by the system 400 and/or the system 600.

The system 700 can include one or more user interface devices 704. The user interface device 704 can include an interface, HDMI interface, a screen, mobile device, etc., that provides supervisory control and user interaction capabilities to a user associated with the converged controller 302. For example, the user interface device 704 can include a touch screen mounted to the converged controller 302 and allow for user input and control. In other embodiments, the user interface device 704 is coupled to and/or otherwise communicable with the cloud computing system 202. In this case, the user interface device 704 can allow for remote monitoring and control of the field equipment 312. The user interface device 704 can receive text, video, and/or image input. The user interface device 708 can include a graphical user interface. In some embodiments, the graphical user interface is the application 206, and can be installed on the computing system 402 and displayed on the user interface 404.

Still referring to FIG. 7, the system 700 can include one or more control systems 702. The control system 702 can be configured to monitor, control, and optimize a performance of the oil-and-gas facility via the converged controller 302, the edge device 204, and/or the field controller 210. The control system 702 can include one or more processors and one or more non-transitory computer-readable medium storing program instructions to be executed by the one or more processors to provide the operations attributed to the control system 702 or its components herein. The control system 702 can be coupled to the user interface device 704. For example, the control system 702 can receive user input from the user interface device 704 and execute an operation as indicated by the user as described further herein. The control system 702 can also control the user interface device 704 to provide a user with a prompt via the graphical user interface. Various functions described with reference to the components of the system 700 described further herein can be performed in various orders and/or combined or moved to other components of the system 700.

The control system 702 can include one or more data sources 706. The data sources 706 can include any of various databases, data sets, or data repositories, for example. The data source 706 can be maintained by one or more entities, which may be entities that maintain the system 700 or may be separate from entities that maintain the system 700. For example, the data source 706 can be maintained by the cloud computing system 202. The data source 706 can receive data from the user, third parties, and/or the cloud computing system 202. The data source 706 can include a plurality of constraints (e.g., performance constraints) of the field equipment 312 as well as the converged controller 302. The plurality of constraints can correspond to a plurality of stored variables (e.g., of the field equipment 312). The plurality of stored variables can relate to operations of the oil-and-gas facility (e.g., electricity usage, pump rate, etc.). The plurality of constraints can include, but are not limited to, manufacturer, performance, regulatory, economic, environmental, and/or time constraints for the variables of the field equipment 312, the converged controller 302, and, in some embodiments, the field controller 210 and the edge device 204. For example, the data source 706 can include systems providing and/or be populated to include manufacturer data relating to equipment operating limits, third party data relating to constraints imposed by third parties (e.g., standards setting bodies, regulators, etc.), site-specific constraints derived from operations of a particular site (e.g., particular oil-and-gas facility), etc., in various embodiments.

For example, the oil-and-gas facility can include a plurality of wells. In this case, the plurality of constraints can include well-level constraints associated with each well of the plurality of wells. The plurality of constraints can also include facility-level constraints associated with a combination of the plurality of wells. Each of these constraints can correspond to a variable. For example, a well-level constraint can correspond to a pump rate of the well while a facility-level constraint can correspond to a water usage of the combination of wells.

The data source 706 can also include a plurality of responses corresponding to the plurality of constraints. The plurality of constraints can include upper and lower bounds (e.g., limits) of the plurality of variables. The plurality of responses can be modifications to settings of the oil-and-gas facility performed in response to at least one of the plurality of variables being above the upper bound or below the lower bound and/or by user input. For example, responsive to a motor amps (e.g., a variable) of an ESP violating a constraint (e.g., exceeding an upper bound), the response may be to reduce a VSD output frequency setting. This may modify the variable to be within the lower and upper bounds of the constraint. The plurality of constraints and the plurality of responses may represent various situations and settings of, for example, the field equipment 312. The various situations may include power outages, weather fluctuations, etc. The plurality of responses may also include modifications to the plurality of constraints.

The control system 702 can include one or more device optimizers 708. The device optimizer 708 can optimize (e.g., improve) a performance of one or more devices (e.g., the field equipment 312) of the oil-and-gas facility. The device optimizer 708 may optimize the performance based on a target (e.g., goal, performance indicator) set by the user such as, for example, a target or maximum electricity usage and/or a general goal of minimizing electricity usage (or minimizing emissions, minimizing pollution, maximizing production, etc., in various embodiments). For example, the control system 702 can provide the user with the graphical user interface via the user interface device 704 and request the user to select a performance indicator (e.g., KPI) associated with operations of the oil-and-gas facility. The device optimizer 708 can optimize the performance of the oil-and-gas facility by modifying settings of the one or more devices based on the plurality of constraints (e.g., constraints on variable affected by the one or more devices, constraints on settings used by the one or more devices, etc.). For example, based on the performance indicator, the device optimizer 708 may recommend which of the plurality of constraints and corresponding plurality of stored variables to adjust. The device optimizer 708 may operate concurrently and/or with the user query processor 408. For example, responsive to receiving a query regarding optimizing function of the oil-and-gas facility to target minimal water usage, the user query processor 408 may direct the device optimizer 708 to generate a response to adjust settings of the oil-and-gas facility for minimal water usage.

The device optimizer 708 may request the user to adjust the plurality of constraints on the plurality of stored variables. Responsive to adjustments of the plurality of constraints by the user, the device optimizer 708 can select a response of the plurality of responses based on the performance indicator and adjusted plurality of constraints. Adjustment of the plurality of constraints by the user can be accepted without writing software code. For example, the plurality of constraints may be adjusted by a sliding button on the graphical user interface. The device optimizer 708 can recommend which of the plurality of constraints to adjust based on the performance indicator.

The device optimizer 708 can perform an optimization process to determine settings for the operations of the oil-and-gas facility to optimize the performance indicator. To do this, the device optimizer 708 can be and/or include a rule based engine (e.g., model). The device optimizer 708 can select and apply the plurality of responses. In some embodiments, the user may determine the plurality of responses. Upon receiving data from, for example, the sensor 308, the device optimizer 708 can determine whether variables of the data is within a respective lower bound and upper bound. The device optimizer 708 can then apply at least one of the plurality of responses to adjust settings of the, for example, field equipment 312 coupled to the sensor 308 to modify the variables to be within the respective lower bound and upper bound. For example, given a variable of pump rate, a constraint assigned to the pump rate can have an upper bound and a lower bound. The device optimizer 708 can then determine a response based on both the variable and the constraint. The response can optimize operations of the oil-and-gas facility. The response can adjust settings of the industrial equipment to constrain variables to the constraints. In some embodiments, the response also adjusts the upper and lower bounds of the constraints to optimize the operations based on the performance indicator. In some embodiments, the user selects which of the plurality of variables and constraints to modify to optimize the operations. The response is then determined by the device optimizer 708 based on user input.

The device optimizer 708 can receive a plurality of operation variables from the edge device 204, the converged controller 302, the sensors 308, and other such devices of the oil-and-gas facility. The plurality of operation variables may include manufacturer, performance, safety, regulatory, economic, environmental, and time variables of the field equipment 312, the converged controller 302, and, in some embodiments, the field controller 210 and the edge device 204 of the oil-and-gas facility (e.g., the hydrocarbon site 100). The plurality of operation variables may be dynamic data such as metadata, episodic data, and/or time series data from the oil-and-gas facility. For example, one of the plurality of operation variables may be a pump rate and received as time series data. The plurality of operation variables also include equipment variables (e.g., of the oil-and-gas equipment) and site variables (e.g., the oil-and-gas facility). The plurality of operation variables may also be provided by the user.

The device optimizer 708 can analyze the plurality of operation variables and select a response of the plurality of responses based on the plurality of constraints. The device optimizer 708 can select the response based on the plurality of stored variables and corresponding plurality of constraints. For example, the device optimizer 708 can compare the operation variable to the plurality of stored variables. The device optimizer 708 can then, responsive to determining that the operation variable matches at least one of the plurality of stored variables, apply the response of the plurality of responses corresponding to the at least one of the plurality of constraints to generate the response. For example, one of the operation variables can be a tubing head pressure (e.g., of a tubing string of the well-site). Responsive to the tubing head pressure being above the upper bound and/or by user input, the device optimizer 708 can generate the response to be open choke (e.g., open a choke valve of the well-site). The device optimizer 708 can use a constraint relating to tubing head pressure to generate the response. The response may then be executed by the oil-and-gas facility (e.g., the converged controller 302) to adjust settings of the field equipment 312. For example, the converged controller 302 may control the field equipment 312 to open choke. The converged controller 302 may modify settings of the field equipment 312 to open choke. In some embodiments, the device optimizer 708 provides the user interface device 704 with proposed responses based on the performance indicator. The user can then select which of the responses to execute, and the device optimizer 708 determines modifications to the settings of the field equipment 312 based on the selected responses.

Responsive to none of the plurality of stored variables matching the plurality of operation variables, the device optimizer 708 may not generate a response. The device optimizer 708 can then, instead, generate an alert for the user via the user interface device 704. In some embodiments, the control system 702 includes a plurality of edge controllers (e.g., the edge device 204) and a supervisory controller (e.g., the field controller 210). The plurality of edge controllers can be configured to control the industrial equipment according to the response. The supervisory controller can include the device optimizer 708 and perform the optimization process to provide settings to the plurality of edge controllers. In some embodiments, the control system 702 includes a plurality of converged controllers (e.g., the converged controller 302).

In some embodiments, the device optimizer 708 can use physics and data models to determine the plurality of responses from the plurality of constraints and corresponding plurality of stored variables. The plurality of responses can be set (e.g., determined) by a user. The device optimizer 708 can be included in an application 206, and installed and executed on one or more devices (e.g., the converged controller 302). The lower and upper bounds may be adjusted and/or set by the user. Each of the plurality of responses can correspond to at least one of the plurality of constraints and corresponding plurality of variables.

In some embodiments, the device optimizer 708 includes a machine learning model. The device optimizer 708 can be trained on the plurality of constraints, the plurality of responses, and the plurality of stored variables of the data source 706. In some embodiments, the plurality of responses are determined by the machine learning model and then implemented on the rule based engine. In some embodiments, the machine learning model can generate recommendations for adjusting the constraints. In this case, the device optimizer 708 can determine which adjustments to the plurality of constraints enable an improved value for the performance indicator compared to user selection of the adjustments.

In some embodiments, the devices optimizer 708 implements a constrained optimization using techniques as disclosed in U.S. patent application Ser. No. 18/736,912 filed Jun. 7, 2024, the entire disclosure of which is incorporated by reference herein.

In some embodiments, the device optimizer 708 can use the response to fine-tune the model. For example, the device optimizer 708 can receive information on an impact of the response (e.g., on the oil-and-gas facility) and adjust the plurality of responses based on the impact. The device optimizer 708 may also adjust the plurality of constraints based on the impact. The device optimizer 708 may be constantly adjusted to reflect changes of the received plurality of variables (e.g., from the converged controller 302). For example, the device optimizer 708 may include a model configured to adjust the plurality of responses based on the plurality of variables and the received information on the impact. The device optimizer 708 may be manually adjusted to reflect changes in the received plurality of variables.

In some embodiments, the plurality of constraints includes soft and hard boundaries. The hard boundaries can be the upper and lower bounds, while the soft boundaries can be bounds within the upper and lower bounds. For example, the soft boundaries may include rewards to achieve the performance indicator selected by the user (e.g., implemented as penalties in an objective function for violating the soft boundaries). Thus, responsive to the device optimizer 708 assigning a response and a result of the setting modifications being within the soft boundaries, the device optimizer 708 can be fine-tuned based on the reward (e.g., the device optimizer 708 is rewarded, the objective function does not experience a penalty). The device optimizer 708 can prioritize responses that result in the variable being within the soft boundaries, unless the optimization determines that benefits from violating a soft boundary outweigh an associated penalty.

Based on the responses generated by the device optimizer 708, the device optimizer 708 can communicate with the user interface device 704 to provide visuals to a user. The visuals can include a top to bottom screen visual (e.g., list, order) where the responses are sorted based on which responses is closest to the upper or lower bound of its respective constraint. For example, the variable being at the upper bound would be higher on the user interface device 704 than the variable being above the upper bound or vice versa. The visuals can also include charts (e.g., bar chart, histogram, bubble bar chart) for each of the plurality of variables. The charts can show where each of the plurality of variables lie compare to the upper and lower bounds of the plurality of constraints. The charts can also show a range of the plurality of variables over a selectable (e.g., by the user) period of time. For example, the plurality of variables (e.g., a pump rate) may fluctuate over the selectable period of time. The device optimizer 708 can also provide a graphical user interface to the user interface device 704 based on measurements of at least a subset of the plurality of operation variables provided by, for example, the sensors 308. In this case, the graphical user interface can include visualizations of the measurements together with input fields for the user for adjusting constraints on the subset of the plurality of operation variables.

The visuals can also include a zero-code user experience platform. For example, the user can customize the user interface device 704 to display the plurality of constraints, responses, and/or variables in a specific format. The user can also adjust the upper and lower bounds of the plurality of constraints and other visual elements of the device optimizer 708. Responsive to the user selecting at least one of the responses, the response may be executed by the converged controller 302 on the oil-and-gas facility (e.g., the hydrocarbon site 100). The user interface device 704 may reflect adjustments to the respective variable based on the response.

In some embodiments, the device optimizer 708 may be executed on the converged controller and/or the edge device 204, and may be connected to a plurality of applications 206 directed to wells. The device optimizer 708 may also be connected with a plurality of wells. Based on the plurality of operation variables received from the plurality of applications 206 and the plurality of wells, the device optimizer 708 can generate a localized optima for the plurality of wells. For example, the device optimizer 708 can determine a plurality of responses to optimize a function of the plurality of wells. The device optimizer 708 can generate the localized optima based on the performance indicator (e.g., reduce expenses) by applying the plurality of responses to the plurality of wells. The, for example, operational advisor 412 can also control well cycle testing (e.g., operate the wells, adjust parameters) for each of the plurality of wells. The operational advisor 412 can also collect CO2 information regarding the plurality of wells and provide the information to the device optimizer 708. The device optimizer 708 can then receive a maximum CO2 level, recommend to the user which constraints to adjust, and generate a response based on the constraint adjustment to maintain CO2 levels below the maximum. In some embodiments, the device optimizer 708 generates a response for each relevant variable to CO2 levels and requests the user to select which responses to execute.

In some embodiments, the device optimizer 708 can limit a usage of water within a plurality of fields where the plurality of wells are located. For example, the device optimizer 708 can receive a maximum water usage for the plurality of wells as the performance indicator The device optimizer 708 can then determine a response based on the plurality of operation variables and corresponding plurality of constraints regarding water usage for each of the plurality of wells as well as the performance indicator. The device optimizer 708 can then maximize oil production of the plurality of wells while also limiting water usage. The device optimizer 708 may take into account oil collection rates, power usage, water usage, and other variables to determine the response.

In some embodiments, the device optimizer 708 can optimize chemical injection within the plurality of wells. The chemicals can be used to mitigate corrosion, bacteria growth, hydrate development, etc. within the plurality of wells. The device optimizer 708 can receive a plurality of variables directed towards cost and volume of chemical injections, and determine a plurality of responses for each of the plurality of wells for a volume of chemical to inject into each of the plurality of wells to optimize the performance indicator (e.g., mitigate corrosion). The user may select which of the plurality of wells to execute the plurality of responses on. In some embodiments, the device optimizer 708 can adjust the performance indicator by generating responses to modify settings of the plurality of wells over a life of the plurality of wells. In this case, the operational advisor 412 can also monitor a health of chemical injection pumps and recommend refilling a chemical tank of the chemical injection pumps.

In some embodiments, the operational advisor 412 can calculate savings generated based on a calculation of losses (e.g., monetary losses) mitigated by executing the plurality of responses determined by the device optimizer 708. The operational advisor 412 can also generate a visual for display on the user interface device 704 to demonstrate a plurality of losses prevented compared to the plurality of variables prior to modifying the settings. In some embodiments, the operational advisor 412 can also receive data on power and energy of all the field equipment 312 connected to the converged controller 302. The operational advisor 412 and/or the device optimizer 708 can generate a visual directed towards an energy footprint (e.g., the power and energy) of the field equipment 312 for the user interface device 704. In this case, the operational advisor 412 and/or the device optimizer 708 can also analyze and monitor the power and energy of both the converged controller 302 and the field equipment 312.

In some embodiments, the device optimizer 708 can include a model predictive control (MPC) system that utilizes conditions-based (e.g., constraint-based) control schemes (e.g., the plurality of rules). The MPC system can be created without a reduced order model (ROM) or physics-based models. A primary condition (e.g., performance indicator) of the MPC system may be a goal-seek and can include, for example, reducing expenses of the hydrocarbon site 100. In this case, the plurality of constraints can include, but not limited to, minimum motor efficiency, maximum drawdown (e.g., pressure reduction) rate, maximum discharge pressure, maximum motor temperature, maximum motor amps (e.g., current), maximum motor torque, maximum operating speed (e.g., rates per minute (RPM)), maximum VSD load, maximum transformer output (kVA), maximum cable kW (e.g., voltage) drop, minimum pump rate of return (ROR), maximum pump ROR, minimum tubing fluid velocity, maximum voltage limit, and minimum system efficiency. Each of the plurality of constraints can be associated with an upper and lower bounds to meet the primary condition. Each of the plurality of constraints may be visualized on the user interface device 704. The primary condition (e.g., optimizing factor, performance indicator) can include, but not limited to, maximum production (e.g., speed), and maximum efficiency. The device optimizer 708 can then, based on the primary condition, generate a plurality of responses for each of the plurality of operation variables based on the plurality of constraints. For example, each of the primary conditions can have a plurality of constraints corresponding to it. The MPC system can be integrated with both torque and energy optimization methods. The torque and energy optimization methods can be included in the device optimizer 708.

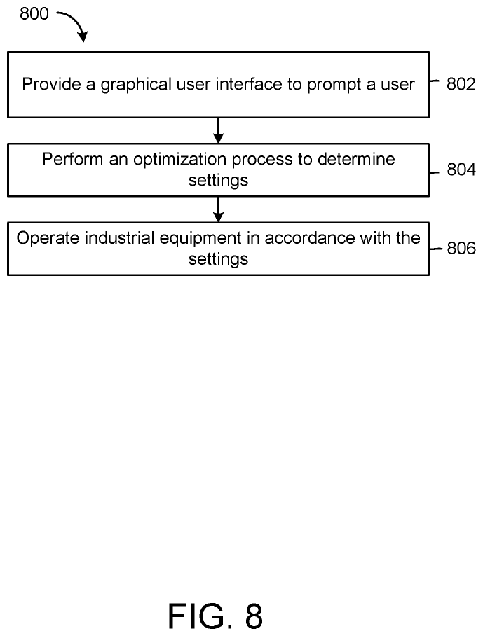

Now referring to FIG. 8, each block of method 800, described herein, includes a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 800 is described, by way of example, with respect to the system 400 and/or the system 500 and/or the system 600 and/or the system 700. However, these methods may additionally or alternatively be executed by any one system, or any combination of systems, including, but not limited to, those described herein.

The method 800 can be directed towards optimizing an oil-and-gas facility. At block 802, a graphical user interface is provided to prompt a user. The graphical user interface can be displayed on a user interface (e.g., the user interface device 704). The prompt can be a request to the user to select a performance indicator associated with operations of the oil-and-gas facility. The performance indicator can be related to, for example but not limited to, water usage, electricity usage, efficiency, etc. The prompt can also request the user to adjust a plurality of constraints on a plurality of variables relating to the operation. The user can adjust the plurality of constraints based on the performance indicator, and a device optimizer (e.g., the device optimizer 708) may provide recommendations for which of the plurality of constraints to adjust. The plurality of variables may include operating variables of the oil-and-gas facility including, for example, but not limited to, motor torque, motor efficiency, motor speed, etc. Block 802 can be performed using a low-code or no-code interface, in various embodiments.

At block 804, an optimization process is performed to determine settings of the operations of the oil-and-gas facility to optimize the performance indicator subject to the plurality of constraints. The optimization process may include a plurality of rules based on the plurality of variables and the plurality of constraints. For example, each of the plurality of rules may correspond to each of the plurality of variables and the plurality of constraints. Responsive, to adjustments to the plurality of constraints, the optimization process may apply the plurality of rules to adjust the plurality of variables to be within the plurality of constraints. The plurality of rules may adjust (e.g., determine) settings of the operations. At block 806, the industrial equipment operates in accordance with the settings. For example, an edge device (e.g., the edge device 204), a control loop of a converged controller (e.g., the converged controller 302), and/or a field controller (e.g., the field controller 210) may receive the settings following the optimization process, and automatically control the industrial equipment using the settings to cause the equipment to operate in accordance with the settings.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining can be stationary (i.e., permanent or fixed) or moveable (i.e., removable or releasable). Such joining can be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (i.e., directly coupled), the generic definition of “coupled” provided above is modified by the plain language meaning of the additional term (i.e., “directly coupled” means the joining of two members without any separate intervening member), resulting in a narrower definition than the generic definition of “coupled” provided above. Such coupling can be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element can be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Although the figures and description can illustrate a specific order of method steps, the order of such steps can differ from what is depicted and described, unless specified differently above. Also, two or more steps can be performed concurrently or with partial concurrence, unless specified differently above. Such variation can depend, for example, on the software and hardware systems chosen and on designer choice. All such variations are within the scope of the disclosure.

It is important to note that the construction and arrangement of the apparatus as shown in the various exemplary embodiments is illustrative only. Additionally, any element disclosed in one embodiment can be incorporated or utilized with any other embodiment disclosed herein. Although only one example of an element from one embodiment that can be incorporated or utilized in another embodiment has been described above, it should be appreciated that other elements of the various embodiments can be incorporated or utilized with any of the other embodiments disclosed herein.

What is claimed is:

1. A system, comprising:
industrial equipment providing operations of an oil-and-gas facility;
a user interface device; and
a control system programmed to:
provide, the user interface device, a graphical user interface configured to prompt a user to:
select a performance indicator associated with the operations; and
adjust a plurality of constraints on a plurality of variables relating to the operations;
perform an optimization process configured to determine settings for the operations that optimize the performance indicator subject to the plurality of constraints; and
operate the industrial equipment in accordance with the settings.

2. The system of claim 1, comprising a plurality of sensors configured to provide measurements of at least a subset of the plurality of variables, wherein the control system is further programmed to provide the graphical user interface with visualizations of the measurements together with input fields for adjusting the constraints on the subset of the plurality of variables.

3. The system of claim 1, wherein the control system is further programmed to generate, using a model, a recommendation for adjusting the plurality of constraints, wherein the model predicts that implementing the recommendation will cause an improved value for the performance indicator.

4. The system of claim 1, wherein the graphical user interface accepts selection of the performance indicator and adjustment of the plurality of constraints without requiring the user to write software code.

5. The system of claim 1, wherein the oil-and-gas facility comprises a plurality of wells, and wherein the plurality of constraints comprises well-level constraints associated with particular wells of the plurality of wells and facility-level constraints associated with a combination of the plurality of wells.

6. The system of claim 1, wherein the control system comprises a plurality of edge controllers configured to control the industrial equipment in accordance with the settings and a supervisory controller configured to perform the optimization process and provide the settings to the plurality of edge controllers.

7. A method for operations of industrial equipment at an oil-and-gas facility, comprising:
providing, via a user interface device, a graphical user interface configured to prompt a user to:
select a performance indicator associated with the operations; and
adjust a plurality of constraints on a plurality of variables relating to the operations;
performing an optimization process configured to determine settings for the operations that optimize the performance indicator subject to the plurality of constraints; and
operating the industrial equipment in accordance with the settings.

8. The method of claim 7, comprising;
measuring, by sensors, at least a subset of the plurality of variables; and
providing the graphical user interface with visualizations of measurements from the sensors together with input fields for adjusting the constraints on the subset of the plurality of variables.

9. The method of claim 7, further comprising generating, using a model, a recommendation for adjusting the plurality of constraints, by predicting, by the model that implementing the recommendation will cause an improved value for the performance indicator.

10. The method of claim 7, comprising accepting, by the graphical user interface, selection of the performance indicator and adjustment of the plurality of constraints without requiring the user to write software code.

11. The method of claim 7, wherein the oil-and-gas facility comprises a plurality of wells, and wherein the plurality of constraints comprises well-level constraints associated with particular wells of the plurality of wells and facility-level constraints associated with a combination of the plurality of wells.

12. The method of claim 7 wherein operating the industrial equipment in accordance with the settings comprises:
distributing the settings from a supervisory controller that performs the optimization process to a plurality of edge controllers; and
controlling, by the plurality of edge controllers, the industrial equipment.

13. The method of claim 12, wherein the industrial equipment comprises pumps.

14. The method of claim 7, wherein the performance indicator correspond to a production of the oil-and-gas facility.

15. The method of claim 7, wherein the settings adjust an amount of injection provided to a well.

16. One or more non-transitory computer-readable media storing program instructions that, when executed by one or more processors, cause the one or more processors to perform operations comprising:
providing, to a display device, a graphical user interface prompting a user to:
select a performance indicator associated with operations of industrial equipment of an oil-and-gas facility; and
adjust a plurality of constraints on a plurality of variables relating to the operations;
performing an optimization process configured to determine settings for the operations that optimize the performance indicator subject to the plurality of constraints; and
operating the industrial equipment in accordance with the settings.

17. The one or more non-transitory computer-readable media of claim 16, wherein the operations comprise:
receiving, from sensors, measurements at least a subset of the plurality of variables; and
providing the graphical user interface with visualizations of the measurements together with input fields for adjusting the constraints on the subset of the plurality of variables.

18. The one or more non-transitory computer-readable media of claim 16, wherein the operations comprise generating, using a model, a recommendation for adjusting the plurality of constraints, by predicting, by the model that implementing the recommendation will cause an improved value for the performance indicator.

19. The one or more non-transitory computer-readable media of claim 16, comprising providing adjustment of the plurality of constraints without requiring the user to write software code.

20. The one or more non-transitory computer-readable media of claim 16, wherein the oil-and-gas facility comprises a plurality of wells, and wherein the plurality of constraints comprises well-level constraints associated with particular wells of the plurality of wells and facility-level constraints associated with a combination of the plurality of wells.
